(19) United States
(12) Patent Application Publication
(10) Pub. No.: US 2010/0223153 A1
(43) Pub. Date: Sep. 2, 2010

(54) SYSTEM AND METHOD FOR MANAGING SALE OF PRODUCT BASED ON TIME COST

(76) Inventor: Yong Gyun Sin, Seoul (KR)

Correspondence Address: EDWARDS ANGELL PALMER & DODGE LLP, P.O. BOX 55874, BOSTON, MA, 02205, US

(21) Appl. No.: 12/095,739

(22) PCT Filed: Dec. 1, 2006
(86) PCT No.: PCT/KR2006/005157

§ 371 Date: Jun. 1, 2008

(30) Foreign Application Priority Data
Dec. 2, 2005 (KR) 10-2005-0117174

(51) Int. Cl. G06Q 30/00; G06Q 10/00; G06Q 20/00

(52) U.S. Cl. 705/27

(57) ABSTRACT

The present invention relates to product sale management system and method based on time-cost. The product sale management system for executing product sale management based on time-cost according to the present invention comprises a sale management server including a member subscribing unit receiving member information from a user connected to a home page and issuing a membership card to admit the user as a member; a product list providing unit providing the user with a product list to which time-cost is applied; an order reservation receiving unit receiving order information including a consumption period (i.e. product receipt date) and a place of delivery (i.e. a local mart) of a specific product in the product list from the user; and an order processing unit transmitting the order information to a corresponding seller and a place of delivery.

### TECHNICAL FIELD

The present invention relates to product sale management system and method based on time-cost, and in particular to product sale management system and method which receive an order reservation on-line from a final customer, manage the production and distribution of a product in consideration of a consumption period of the consumer, and deliver the product to a local mart set by the customer thereby to provide the product at a product price exclusive of distribution and management cost.

### BACKGROUND ART

The current product price is determined by various factors, and the factors have direct prime cost items including material cost, labor cost or any other production expenses, and distribution and management cost items including selling expense, general management expense or any other distribution and management expenses, and in particular, the latter is a price determining factor commonly input regardless of the kind of product.

Particularly, the above-mentioned distribution and management cost may be typically three times as much as the direct prime cost, and if the sale period is delayed, the distribution and management cost increases proportionally. And, if the sale period is delayed indefinitely, overstock is generated, which may cause damage to a producer or a seller.

After products are produced, costs are incurred daily as time goes by until the products are sold by final customers. Taken the incurred costs into consideration, the product price of each product should be flexible as time goes by, but at present the product price is fixed and the distribution and management cost is indiscriminately applied to the product price without reflecting variations of the intermediate distribution and management cost, and as a result, when purchasing a product, a consumer pays the fixed cost, and if the product is overstocked, a producer or a seller bears the cost.

And, in the case that a user purchases a specific product at an on-line shopping mall, it is general that the user purchases a product without knowing certainly the inventory status or delivery status of the product. If the user requests a purchase for a product not on hand, the user may be recommended to cancel the purchase request from seller later, or may receive the product with delivery delay or cancel the purchase due to a breach of contract, and in frequent instances, the user may not obtain a desired product in time nor receive a purchase, and as a result, time and economic damage occurs.

Particularly, if a customer purchases a product by prior purchase or advance order, the indiscriminate product price determined out of consideration of the customer may be unreasonable. And, it may be uneconomical to apply the same price to customers having different purchase propensities or utilities due to bubbles of price determining factors to be input regardless of actual costs rendered in the actual distribution process. Such a conventional method for determining the product price in the distribution process may be inappropriate to an electronic trade system available at present, and thus the related industry has been developing a new trade method suitable for the current trade method or system, and the present invention is devised under this technical background.

### DISCLOSURE

### Technical Problem

The present invention is designed to solve the above-mentioned problem of the prior art, in other words, to improve a flat application method of the product price while suggesting a preferable type trade method between all of a consumer and a seller or a producer, and therefore, in order to solve the technical problems, it is an object of the present invention to provide a product sale management service based on time-cost incorporating timely consumption according to optimal supply state using on-line order and off-line supply of local marts handling nationwide time-cost products in consideration of a consumption period of a customer of each product and a manufacture period of each product on-line on a wire or wireless communication network.

### Technical Solution

In order to achieve the above-mentioned objects, according to a product sale management system of the present invention, in the system for executing product sale management based on time-cost ranging from production to sale of a product on a wire or wireless communication network, the system comprises a sale management server including a member subscribing unit receiving member information from a user connected to a home page and issuing a membership card to admit the user as a member; a product list providing unit providing the user with a product list to which time-cost is applied; an order reservation receiving unit receiving order information including a consumption period and a place of delivery, for example a local mart of a specific product in the product list from the user; and an order processing unit transmitting the order information to a corresponding seller and the place of delivery.

According to preferred features of the present invention, the product sale management system further comprises a user terminal transmitting a subscription application to the sale management server, receiving the product list, transmitting the order information and making an order reservation; a seller terminal receiving the order information from the sale management server and dispatching a corresponding product made to order; and a deliverer terminal receiving the order information from the sale management server and if the product is dispatched from the seller, receiving and identifying the membership card of the user and determining if the product made to order should be delivered over to the user.

And, according to a product sale management method based on time-cost of the present invention, in the method for executing product sale management based on time-cost ranging from production to sale of a product on a wire or wireless communication network, the method comprises (S1) the sale management server receiving member information from the user terminal on the home page and issuing a membership card to admit a member; (S2) providing the user terminal on the home page with a product list to which time-cost is applied; (S3) receiving order information including a consumption period, for example a product receipt date and a place of delivery, for example a local mart of a specific product in the product list from the user terminal and making an order reservation; (S4) transmitting the order information to the corresponding seller terminal and the deliverer terminal and processing the order; and (S5) receiving dispatch information from the seller terminal, receiving delivery information from the deliverer terminal and informing order progress information to the user.

### DESCRIPTION OF DRAWINGS

Preferred embodiments of the present invention will be more fully described in the following detailed description, taken accompanying drawings. However, it should be understood that the description proposed herein is just a preferable example for the purpose of illustrations only, not intended to limit the scope of the invention. In the drawings:

FIG. 1 is a block diagram of a product sale management system based on time-cost in accordance with an exemplary embodiment of the present invention.

FIG. 2 is a functional block diagram of a sale management server in accordance with an exemplary embodiment of the present invention.

FIG. 3 is a whole flowchart of a product sale management method based on time-cost in accordance with an exemplary embodiment of the present invention.

FIG. 4 is a detailed flowchart of an order reservation receiving step shown in FIG. 3.

FIG. 5 is a detailed flowchart of a step for informing dispatch information and delivery information shown in FIG. 3.

### BEST MODE

Hereinafter, preferred embodiments of the present invention will be described in detail with reference to the accompanying drawings.

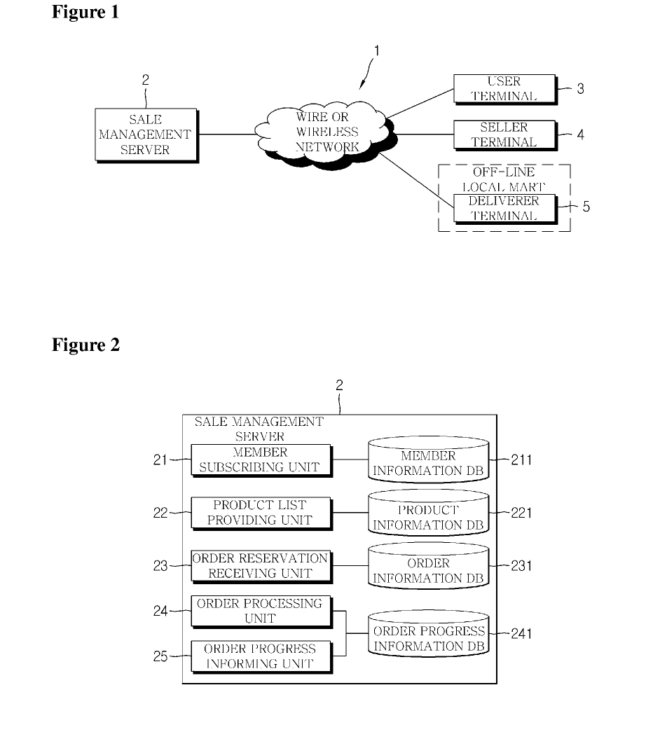

FIG. 1 is a block diagram of a product sale management system 1 based on time-cost in accordance with an exemplary embodiment of the present invention.

The product sale management system 1 according to an exemplary embodiment of the present invention comprises a sale management server 2, a user terminal 3, a seller terminal 4, and a deliverer terminal 5.

When receiving an order from a user, a product sale management service based on time-cost of the present invention provided by the product sale management system 1 receives a consumption period registered by the user, for example product receipt date, and controls the production, distribution and storage of the product so as to provide the product to the user before the due date thereby to sell the product with the product price exclusive of an intermediate management cost. The product in the present invention is a material product and is not limited to a specific kind of product. However, the product may be for various events, of which product receipt date is important to a user, for example wedding ceremony, first birthday, sixth birthday or sacrificial rites.

The sale management server 2 provides the product with the product price deducted selling expense, general management expense and any other distribution and management expense included in distribution and management cost items from the general selling price in consideration of time-cost, i.e. time prime cost. That is, the sale management server 2 provides the product with lower price by minimizing intermediate costs ranging from production to sale of the product offered for sale.

For this purpose, the sale management server 2 has a home page enabling interface with the user through a wire or wireless network. The sale management server 2 provides a member user with product information to which time-cost is applied, and receives an order in advance through the home page. Here, the product information may be data registered directly in the above-mentioned home page or link data of product information registered in a shopping mall home page of a seller.

The user terminal 3 is connected to the home page of the sale management server 2, and applies for subscription and receives a membership card. The membership card is used as a user authorization means when the user receives the product made to order. The user is provided with the product to which time-cost is applied and determines whether or not to make an order on the home page. Preferably, when providing the user with the price to which time-cost is applied, the sale management server 2 also provides the original price through the home page so that the user estimates the discount rate thereby to promote the purchase of the user. And, it is preferred that the home page displays the minimum period from order to product receipt date of the user. For example, if product preparation period of a specific product A is 3 days, the user designates product receipt date to 3 days or more from the order date.

The seller terminal 4 registers product information to which time-cost is applied, on the home page. Here, the seller is a manufacturer, a distributor or an intermediate seller. And, the user is provided from the sale management server 2 with order information made to order through the home page. When the seller receives order reservation information of the user, the seller prepares suitably the production or distribution of the product in consideration of the product receipt date and a place of delivery of the user, and provides timely the product before the due date. Therefore, a final consumer is set at the time of manufacturing the product, thus the seller reduces the selling expense and general management expense thereby to reduce a consumer price of the product, and the reduced price of the product enables the consumer to reasonably and economically consume.

The deliverer terminal 5 is installed at a local mart selected as a place where the user receives the product. A business man of the sale management service based on time-cost of the present invention makes an agreement with off-line local mart owners all over the country through a contract to receive and store products made to order reservation and deliver the product at the request of the user. Here, the local mart owner is identical with the seller of the present invention and may directly provide the user with the product of a producer (i.e. a manufacturer).

The local mart may be a mart run directly by the service businessman of the present invention or a mart in cooperation. When an order for a product is made from the user, order information is transmitted from the sale management server 2 to the seller terminal 4 and is informed to the deliverer terminal 5. Thus, if the product is delivered in the local mart, it may be judged through the deliverer terminal 5 if the place of delivery is correct. And, if the user visits the mart and requests to receive the product, the membership card number presented by the user is input to the deliverer terminal 5 to identify the user. If the user identification is success, the product is delivered to the user, and user receipt confirmation information of the product is transmitted to the sale management server 2.

Meanwhile, in the case of exchange or cancellation of the product, the user requests to exchange or cancel the product to the sale management server 2 and places the product in the local mart thereby to complete the exchange and cancellation.

FIG. 2 is a functional block diagram of the sale management server 2 in accordance with an exemplary embodiment of the present invention.

The sale management server 2 in accordance with an exemplary embodiment of the present invention includes a member subscribing unit 21, a product list providing unit 22, an order reservation receiving unit 23, an order processing unit 24 and an order progress informing unit 25. And, the sale management server 2 of a database management system (DBMS) structure includes a member information DB 211, a product information DB 221, an order information DB 231 and an order progress information DB 241.

The member subscribing unit 21 receives member information from the user connected to the home page of the sale management server 2, issues a membership card and admits the user as a member. Information of the subscribed user is stored in the member information DB 211.

The product list providing unit 22 receives a search request of the user, searches the product to which time-cost is applied, from the product information DB 221, generates a product list and provides a search service to the user through a web page.

When the user selects a specific product in the product list and makes an order for the product, the order reservation receiving unit 23 receives order information including a consumption period (i.e. product receipt date) and a place of delivery (i.e. a local mart), and stores the order information in the order information DB 231. The below table 1 shows data structure of the order information DB 231 just for illustration only, and is not necessarily limited in this regard.

TABLE 1

| | |
|---|---|
| Order information | User ID + Order date + Product information(product |
| DB | code, name, price) + Product receipt date + Place of |
| | delivery of product + others |

The order processing unit 24 transmits the order information reserved by the user to the corresponding seller terminal 4 to place an order and informs the delivery terminal 5 that the product will be delivered to the place of delivery.

The order progress informing unit 25 receives the order progress information from the seller terminal 4 and the deliverer terminal 5, and provides the order progress status to the user. The order progress information subsequent to the user's product ordering includes the seller's order receiving, the seller's product dispatching, delivery of the product, the user's product receiving and so on. The below table 2 shows data structure of the order progress information DB 241 just for illustration only, and is not necessarily limited in this regard.

TABLE 2

| | |
|---|---|
| Order progress | Date + Progress status + Date + Progress status + others |
| information DB | |

The order progress information in the above-mentioned table 2 is provided through the home page to the user requested to search the order progress status of the product, and if the user applied to be informed of the order progress status via e-mail or SMS, the order progress information is provided to the user through an informing service stage by stage in real time.

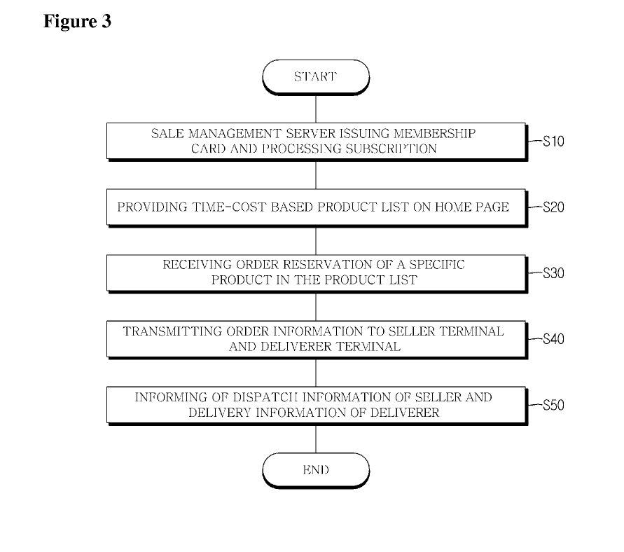

FIG. 3 is a whole flowchart of a product sale management method based on time-cost in accordance with an exemplary embodiment of the present invention.

The user connects to the home page of the sale management server 2 to be provided with the product sale management service based on time-cost of the present invention, is provided with a subscription application page and enters member information to make a subscription (S10). Here, the member information of the user is stored in the member information DB 211, and the sale management server 2 assigns proper membership card number to the user and issues a membership card off-line.

The sale management server 2 receives the user's request to search the product to which time-cost is applied, retrieves the product information DB 221 and provides the user terminal 3 with the web page displaying the product information list (S20).

The user determines to purchase a specific product in the product information list, and the sale management server 2 receives order reservation information input by the user and stores the order reservation information in the order information DB 231 (S30).

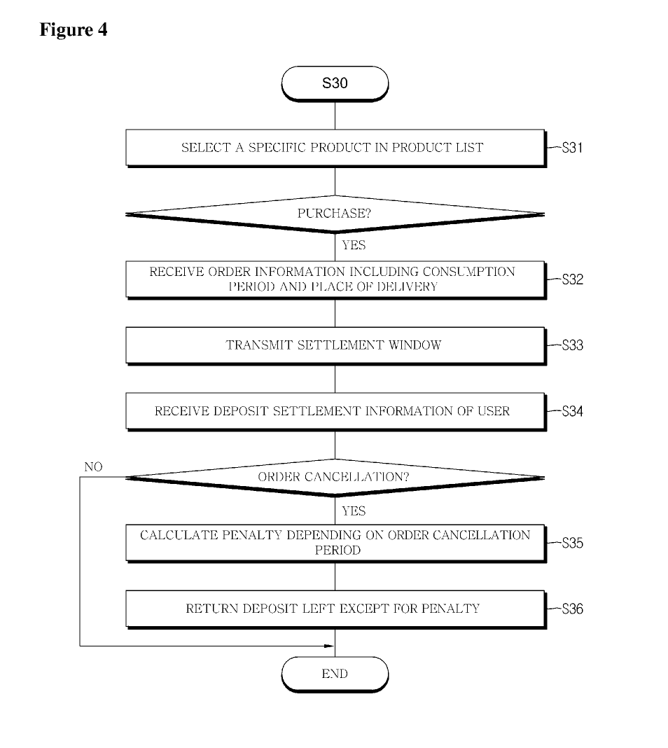

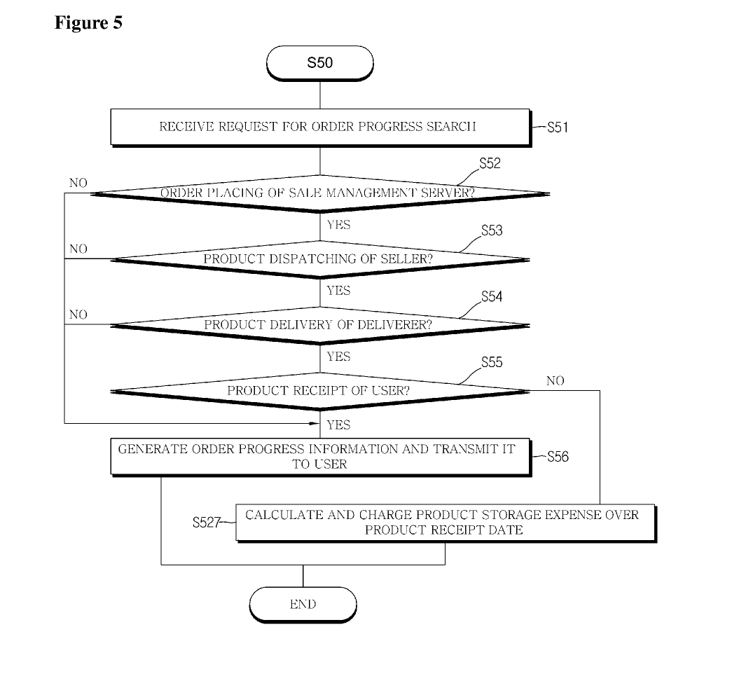

FIG. 4 is a detailed flowchart of the step S30, referring to FIG. 4, the user is provided with a product list page, selects a specific product and searches the detailed information of the product (S31). When the user determines to purchase the product, the user inputs order information including product receipt data and a delivery mart, and the sale management server 2 receives the order information and stores the order information in the order information DB 231 (S32). And, the sale management server 2 transmits a settlement window to the user (S33), and receives settlement information of a portion or the whole of the product price charged as a deposit through the settlement window (S34). Here, if the seller receives a cancellation request from the user before dispatching the product, the sale management server 2 calculates a penalty caused by order cancellation (S35). In a typical on-line transaction, although the user cancels the order, the user is not charged with a penalty, however order of the user is linked directly with production or supply of a product in the present invention, and thus the penalty should be charged (it is also possible not to charge the penalty according to service policy). When the penalty is calculated, the sale management server 2 returns the price deducted the penalty from the deposit paid by the user in the manner of return requested by the user (S36).

Referring to FIG. 3, the sale management server 2 transmits the order information of the user to the corresponding seller terminal 4 to inform manufacture (or supply) of the product and transmits the order information to the delivery terminal 5 to inform that the product is to be delivered to the place of delivery (S40).

And, the sale management server 2 provides the order progress information including dispatch information of the seller and delivery information of the deliverer on the home page at the request of the user, and transmits the order progress information using e-mail or SMS informing means set by the user (S50).

FIG. 5 is a detailed flowchart of the above step (S50). Referring to FIG. 5, after making an order reservation, the user requests to search the order progress on the home page (S51), and the sale management server 2 judges the order progress status. The sale management server 2 judges if the order received from the user was placed into the seller terminal 4 (S52). If the order placing is completed, the sale management server 2 judges if the seller started to dispatch the product (S53). If the product dispatch is confirmed, the sale management server 2 judges if the product is delivered to the place of delivery (S54). If the product delivery is confirmed, the sale management server 2 judges if the user received the product (S55). The sale management server 2 generates the order progress information based on information of judgment collected in the above steps (S52) to (S55) and informs the user of the order progress information (S56). And, in the above step (S55), if the user does not receive the product over the product receipt date, the sale management server 2 calculates and charges product storage expense in proportion to the elapsed period (S57). Accordingly, the user failed to keep to the product receipt date should pay additionally a predetermined product storage expense to receive the product. Here, the product storage expense may be not charged according to business policy, but in the case of products of which quality is damaged as the product receipt date elapses (for example, foods), the product storage expense should be fully charged to the user.

Hereinabove, the product sale management system and method based on time-cost according to the present invention have been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

The product sale management system and method based on time-cost according to the present invention have such effects that the seller confirms the demand for orders of final consumers through an advance order, and manufactures or supplies products, which saves intermediary management expenses of the product and remarkably reduces the stock rate of the product. And, buyers can purchase products with a competitive cost deducted the intermediate expenses from the final selling price through an advance order, thereby resulting in sound consumption through planned purchase.

1. A product sale management system for executing product sale management based on time-cost ranging from production to sale of a product on a wire or wireless communication network, the system comprising a sale management server, the sale management server including:
a member subscribing unit for receiving member information from a user connected to a home page and issuing a membership card to admit the user as a member;
a product list providing unit for providing the user with a product list to which time-cost is applied;
an order reservation receiving unit for receiving order information including a consumption period and a place of delivery of a specific product in the product list from the user; and
an order processing unit for transmitting the order information to a corresponding seller and the place of delivery.

2. The product sale management system of claim 1, further comprising:
a user terminal for transmitting a subscription application to the sale management server, receiving the product list and transmitting the order information to place an order reservation;
a seller terminal for receiving the order information from the sale management server and dispatching a corresponding product made to order; and
a deliverer terminal for receiving the order information from the sale management server, and if the product is dispatched by the seller, receiving and identifying the membership card of the user and determining if the product made to order should be delivered to the user.

3. The product sale management system of claim 1,
wherein the sale management server further includes:
an order progress informing unit for receiving dispatch information from the seller, receiving delivery information from the deliverer and informing order progress information to the user.

4. The product sale management system of claim 1,
wherein the product sale management server further includes:
a member information DB for storing member information including the name, address, phone number and membership card number of the user;
a product information DB for storing product information including the name, price and minimum distribution period of a product to which time-cost is applied;
an order information DB for storing order information including receipt date, delivery mart and deposit of the product made to order reservation by the user; and
an order progress information DB for storing order progress information of the product made to order.

5. The product sale management system of claim 2,
wherein the deliverer terminal is installed at a directly-controlled mart or an affiliated mart in a region selected as the place of delivery by the user.

6. The product sale management system of claim 1,
wherein, if the user receives the product over the reserved product receipt date, the sale management server charges additionally a predetermined product storage expense in proportion to the elapsed date.

7. A product sale management method based on time-cost for executing product sale management based on time-cost ranging from production to sale of a product on a wire or wireless communication network, the method comprising:
(S1) a sale management server receiving member information from a user terminal on a home page and issuing a membership card to admit the user as a member;
(S2) providing a user terminal on the home page with a product list to which time-cost is applied;
(S3) receiving order information including a consumption period and a place of delivery of a specific product in the product list from the user terminal and making an order reservation;
(S4) transmitting the order information to a corresponding seller terminal and a deliverer terminal and processing an order; and
(S5) receiving dispatch information from the seller terminal, receiving delivery information from the deliverer terminal and informing order progress information to the user.

8. The product sale management method of claim 7,
wherein the step (S3) includes the sale management server receiving settlement information of a deposit corresponding to a portion or the whole of the product price from the user and processing the settlement.

9. The product sale management method of claim 7,
wherein the step (S3) further includes, if the sale management server receives order cancellation from the user terminal, the sale management server returning the remaining deposit except for a penalty caused by order cancellation within order cancellation period.

10. The product sale management method of claim 7,
wherein the step (S5) includes receiving a request for order progress search from the user terminal on the home page, providing the user terminal with order progress information, informing information of order receipt, dispatch start and dispatch completion via e-mail or SMS (Short Message Service) by selection of the user.

11. The product sale management method of claim 7,
wherein the step (S5) further includes the sale management server receiving from the deliverer terminal that the product is delivered in the place of delivery, and if the sale management server does not receive information of the user's product receipt over the reserved product receipt date, charging additionally a predetermined production storage expense in proportion to the elapsed date.

12. The product sale management system of claim 2,
wherein the sale management server further includes:
an order progress informing unit for receiving dispatch information from the seller, receiving delivery information from the deliverer and informing order progress information to the user.

13. The product sale management system of claim 2,
wherein the product sale management server further includes:
a member information DB for storing member information including the name, address, phone number and membership card number of the user;
a product information DB for storing product information including the name, price and minimum distribution period of a product to which time-cost is applied;
an order information DB for storing order information including receipt date, delivery mart and deposit of the product made to order reservation by the user; and
an order progress information DB for storing order progress information of the product made to order.

14. The product sale management system of claim 2,
wherein, if the user receives the product over the reserved product receipt date, the sale management server charges additionally a predetermined product storage expense in proportion to the elapsed date.

15. The product sale management method of claim 8,
wherein the step (S3) further includes, if the sale management server receives order cancellation from the user terminal, the sale management server returning the remaining deposit except for a penalty caused by order cancellation within order cancellation period.

16. The product sale management method of claim 10,
wherein the step (S5) further includes the sale management server receiving from the deliverer terminal that the product is delivered in the place of delivery, and if the sale management server does not receive information of the user's product receipt over the reserved product receipt date, charging additionally a predetermined production storage expense in proportion to the elapsed date.
